(19) United States
(12) Patent Application Publication
(10) Pub. No.: US 2026/0362508 A1
(43) Pub. Date: Nov. 12, 2026

(54) SYSTEM AND METHOD FOR CONTROLLING ACCESS

(71) Applicant: Elliptic Laboratories ASA, Oslo (NO)

(72) Inventors: Tom Øystein KAVLI, Oslo (NO); Tobias BORÉN SVENDSEN, Oslo (NO)

(73) Assignee: Elliptic Laboratories ASA, Oslo (NO)

(21) Appl. No.: 19/119,024

(22) PCT Filed: Nov. 16, 2023
(86) PCT No.: PCT/NO2023/060093

§ 371 Date: Apr. 7, 2025

(30) Foreign Application Priority Data
Nov. 18, 2022 (NO) 20221243

(51) Int. Cl. H04W 76/10; G01S 5/18

(52) U.S. Cl. CPC H04W 76/10; G01S 5/18

(57) ABSTRACT

The invention relates to a system for establishing wireless connection between a mobile first device and a second device, as well as a method and method for achieving the connection The devices being configured for wireless communication using a known communication protocol, the second device including an acoustic transmitter configured to transmit acoustic signals in the ultrasound range. The first device comprising at least two transducers of which at least one is an acoustic receiver configured to receive signals within said ultrasonic range. The first device is also configured to measure at least partially based on the acoustic signal received at said receiver and calculate the movement of the first device relative to the second device, and wherein the first device is configured to initiate the wireless communication when the movement of the first device is within determined limits relative to the direction toward the second device.

The present invention is related to a system and method for controlling access to an external device such as a Wi-Fi system or an external speaker system.

Public areas such as stores, coffee shops, hotels and restaurants often provide WiFi access to their customers. It is, however, difficult to limit the access to the intended area and users as the signal often will have sufficient strength to be received outside the area. In order to limit access to customers only, a variety of authentication schemes exists, such WPA/Password signs inside the location, user subscription logins, login coupons etc. Most of these schemes lacks a notion of presence in order to limit the service to customers inside the premises. In other words, one may often gain access by being within WiFi range given the authentication information. Thus, there is a need for a way to control the access to an area inside the WiFi range. Similar problems are also related to other types of wireless systems such as Bluetooth used for local control of devices.

Another problem is that the number of devices is increasing making it harder to select. Usually, it means selecting a specific device from a list of devices in a menu where sometimes the displayed device identifiers may be hard to understand for the users.

In U.S. Pat. No. 10,331,166 it is described how two or more devices determine their relative positions and orientation based on ultrasound signals transmitted between the devices. With one speaker and two microphones on each device the positioning can be done in 2D like on a table surface. By adding more transduces the method can be generalized to work in 3D. Radio communication (Bluetooth or WiFi) can be used to add communication capacity between devices and to give additional possibilities for device synchronization. The solution does however not avoid unwanted connections in more complex situations involving a larger number of devices. In US2021/0400417 an audio system is described where different devices are able to determine relative positions and orientations. Similarly EP3968295 describes a where two devices are capable of measuring the relative positioned between them. In addition, in a separate operation, WiFi or similar technologies may be used to initiate communication between the device.

It is therefore an additional object of the present invention to provide a solution for selecting the correct device among all the available devices in a room. This is obtained as specified in the accompanying claims.

The present invention is thus based on the realization that many devices have a at least one speaker for generating acoustic signals thus constituting a sound source in addition to the electromagnetic communication. Also, most mobile devices have at least one but usually more than two microphones in addition to transducers for electromagnetic communication.

Most speakers and acoustic transducers are capable of transmitting and receiving signals in the near ultrasonic range, just outside the audible range. The wavelengths in the ultrasound domain is also relatively short and therefore two acoustic sensors positioned at a distance of a few millimeters can be configured to sense the differences in reception time, e.g. by the phase difference, between the two received signals. Therefore, using two transducers, the direction from the receiver to the source may be calculated. Based on the direction, the device may thus choose which of the stationary devices in an area it should connect to.

The present invention thus is configured to use the acoustic signal to measure the movement and to use this movement to initiate the communication when the direction of the movement is related to the direction toward the second device.

One embodiment, the present invention may involve the use of an Inertia measuring unit (IMU) and/or magnetometer (compass) on the devices, such as smartphones and tablets, in combination with movements of the devices can be used to:
1. Improve the accuracy and robustness of the position estimates in general. Filtering and smoothing of the position estimates, and detection and removal of outliers is one such use.
2. Resolve ambiguities in the position estimates.
3. Give new capabilities for estimating more position parameters with limited number of acoustic transducers on each device
4. Improve robustness if one or more of the acoustic transducers are occluded or affected by an object in the near environment like a gripping hand
5. Allow activation of the positioning system only when needed, i.e. after the device has been moved, and thereby save power.
6. Use stored maps of earlier detected and positioned devices, such as IoT devices within a room, as a prior for where devices are positioned the next time you enter that room with a mobile device like a smartphone. The magnetometer can be used to give a rough initial estimate of the orientation or the mobile device relative to the room.

In many cases it can be assumed that one of the devices has the role of being a primary device that wants to map the position of all the other devices (i.e. secondary devices) in its environment, while the other devices are ignorant about the other devices around it. An example of this can be that the smartphone (primary device) is used to control IoT devices in its surroundings, and that it wants to know the distance and direction to the different IoT devices. In other cases, all devices may want to know about all other devices and their relative positions. Examples of that can be meshes of sensors placed within an area such as a building. In this case the notion of a primary or secondary device is not necessary since all the devices are equal

The invention will be described below with reference to the accompanying drawings, illustrating the invention by way of examples.

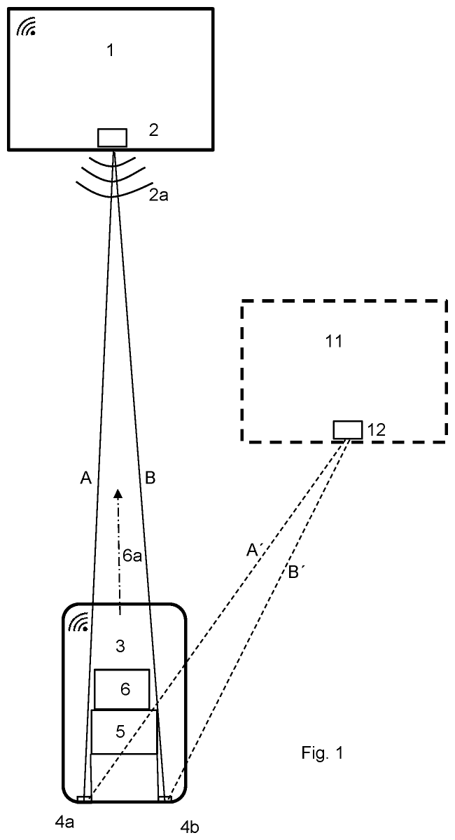

FIG. 1 illustrates the concept of the present invention.

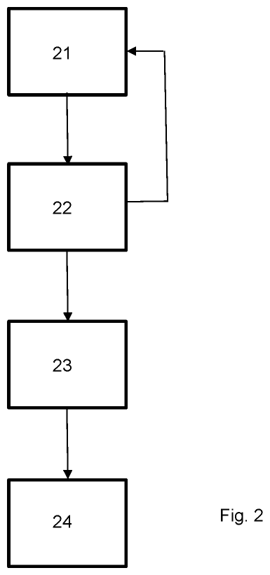

FIG. 2 illustrates the method performed according to the present invention.

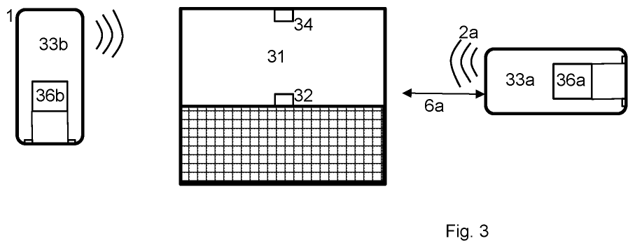

FIG. 3 illustrates a case where a primary device, illustrated as a laptop, has identified the position of two mobile phones.

As is illustrated in FIG. 1, illustrating a preferred embodiment of the invention, the system includes a first, stationary device 1 including an ultrasound transmitter 2 transmitting an acoustic signal 2a. It also includes a wireless communication unit such as WiFi, Bluetooth, etc as will be explained below. It should be noted that the term “stationary device” is to be understood as a device that has a defined position or movement relative to the mobile device allowing the user to point the mobile device in the direction of the stationary device.

The portable device 3 in this case includes two microphones 4a,4b capable of receiving the ultrasound signal. The microphones are positioned at a distance C from each other and thus receives acoustic signals that have propagated over different propagation paths A, B. Both microphones 4a,4b are connected to a processor 5 which in a per se known way is adapted to compare the signals from the microphones. In the illustrated example, the microphones 4a,4b are positioned at the lower part of a mobile phone, and when the mobile phone is pointed in the direction of the first stationary device 1 the signals at the microphones 4a,4b will have had the same propagation length and will therefore be in phase.

When the processor 5 finds that the signals received at the microphones are in phase the device 3 may then decide that the first stationary device 1 is selected and can initiate a connection routine. The connection routine may include a confirmation in the user interface, using the screen, by moving the mobile device in a predetermined way or by approaching the stationary device.

In the illustrated example, a second stationary device 11 is illustrated also including a speaker 12 emitting an ultrasonic signal, but in this case the propagation paths A′, B′ are different and thus the device will not be selected.

Other embodiments may be contemplated, e.g. positioning of the microphones along the mobile device in the pointing direction defining the direction as a predetermined phase difference. Alternatively, the mobile device combines the signals from one microphone and e.g. a WiFi receiver. The acoustic signals may simply be a sine wave but is preferably an encoded or combined signal to avoid ambiguity in different directions or identifying devices configured to be accessible by the system. It may also be possible to measure time delay if the stationary device retransmits a signal emitted from the mobile device requesting a connection, but this may be more complicated than measuring the acoustic phase difference locally. The acoustic sensors or microphones may also be combined with other sensors, such as providing inertia measurements using an IMU 6 for detecting movements 6a of the device 3 communicating the movements 6a to the processor 5 possibly detecting movements, patterns of movements, gestures which may be used to confirm the selection, e.g. by moving toward the selected stationary device, rotating the device 3 etc. The detected movements may thus include both translational movements and rotational movements, e.g. detected by compass, gyro etc.

Once the mobile device has identified the stationary device 1, the wireless signal from the device must be identified, for example as mentioned above by moving toward the stationary device and monitoring the distance. The wireless connection may for example be obtained if the acoustic signal from the stationary device is encoded with a code corresponding to the identity of the stationary device. The mobile device can then request access to the specific stationary device.

Since the ultrasound messages for all practical purposes are constrained within the room where the access point is transmitting by physical properties of ultrasound, as discussed in WO2022189140 or US2013/322214, the ultrasound messages can include information about how to connect to the wireless network handled by the wireless access point.

The messages can include the SSID and corresponding password information enabling the recipients of the ultrasound message to connect to the wireless network seamlessly. Even though the information extracted from the ultrasound messages are not used for automatically connecting to the wireless network, these ultrasound message can be used to select the relevant wireless access point.

For example, in an embodiment involving small cellular base stations, transmitting ultrasound from the cellular base station (CBS) will enable the User Equipment (UE) to filter out all the CBS' outside the space or room where the UE currently resides. In an apartment building where multiple CBS's have been installed, it can be a problem for a UE to select the preferred CBS. If the CBS can transmit ultrasound messages and the UE can receive them, the messages can be used by the UE to connect to the CBS in the same room, and not the CBS with for example the highest signal strength.

The ultrasound message may include additional information about the cellular network including cost, QoS parameters, etc that will allow the UE to make an informed decision whether it should connect via the CBS or not. It is also possible that the UE and CBS exchange multiple ultrasound messages. The messages can be used to send secured messages between the devices to verify that the UE is allowed to connect to the CBS. The messages can also be used to measure the distance between devices as described in Norwegian application NO20221247. Based on these distance measurements, the either UE or CBS may disallow the UE to connect to the cellular network via the CBS. There may be other conditions too that will control when or if the UE is allowed to connect to the CBS.

The stationary device mentioned above may in some cases be a device setting up an ad-hoc wireless network such as a laptop, tablet, Smartphone, etc, e.g. in a mesh network configured to connect other nearby devices in a seamless way. One possible solution is using WiFi direct where the WiFi direct group owner can transmit ultrasound messages to the nearby devices enabling the recipients of an ultrasound messages to connect to the wireless network seamlessly. This allows a scenario where a group of people can set up an ad-hoc secured wireless network inside the meeting room they are located, e.g. providing a video conferencing system allowing others to connect and participate to the meeting, e.g. by screen sharing etc through a local or global network. In this case it may also be convenient to be able to measure the relative position and orientation between the units, such as discussed in NO20221247.

The transmission of ultrasound messages can be limited to periods when presence of someone (i.e. user) or something (e.g. robot, dog, cat etc) is detected by a presence detector unit of any available type. This scheme may reduce the overall message transmission and thereby the power consumption of the solution.

The stationary device may, as an alternative, be a video conferencing system allowing others to connect and participate to the meeting, e.g. by screen sharing etc through a local or global network. In this case it may also be convenient to be able to measure the relative position and orientation between the units, such as discussed in NO20221247.

According to one embodiment of the invention, it may improve the accuracy and robustness of the position estimates in general and saving power by sensor activation only upon movement.

FIG. 3 illustrates a case where a primary unit 31, such as an laptop or stationary device, has identified the position of two secondary units 33a,33b such as mobile phones, through use of ultrasound signaling between the units. If any of the phones 33a, 33b are moved, it may be detected using IMU sensors 36a,36b detecting movements, including rotational and translational movements, the positions should be updated quickly, so the positioning needs to be running continuously. If the user is working on the laptop her hands will occasionally block the ultrasound paths, and there can be large random errors in the estimates. However, continuous monitoring of the IMU (accelerometer and/or gyro) can tell that the phone has not been moved, and the positions should not be updated. And if the phone is moved, inertial navigation methods can be used to estimate the movement of the phone in six degrees of freedom (DOF), or only three DOF when phone is laying on a table, and a sensor fusion algorithm such as a Kalman filter can be used to regularize the position estimates for the phones. In particular, when the phone is directly to the left or right sides of the screen the vertical position estimates will be very coarse, and movements in the vertical direction can be mostly based on the IMU signals.

In practice the system may allow the phone to report that it is moved up, down, rotated, etc according to its reference frame and the primary and secondary devices may communicate so that it is detected whether the devices are moved relative to each other. Thus, if the phone reports a movement upward and the primary device finds that the two devices are getting closer with that movement the system also knows the relative orientation of the phone. If the movement is upwards relative to the phone reference frame and the primary device finds that this movement brings it closer, the system may interpret this as a gesture requesting access to the communication protocol of the primary device. Other definitions may be linked to moving the phone sideways or rotating it relative to the primary device, such as disconnecting or providing input to the software of the primary device. More complex gestures may also be contemplated.

According to another aspect of the invention it may be configured to resolve ambiguities in the position estimates.

In some scenarios there can be several ambiguous positions of the devices that will give identical distances for the acoustic pathways, in which case one cannot determine in which of the ambiguous positions the device is located. In the example below the primary unit 31 in the center has a microphone 34 on the top and bottom, and a speaker 32 at the top. In this case the two peripheral smartphones, one to the left and one to the right of the primary device may give identical acoustic measurements if they are at the same distance. As an alternative a combination of acoustic and electromagnetic measurements may be used for measuring the relative orientation, measuring at least one distance acoustically and using Bluetooth for measuring the second distance.

However, if for instance the phone 33a to the right is moved 6a a little to the left or right, this movement can be measured both with the IMU on the phone and with the ultrasound system on the primary device unit 31. When for instance the right phone reports to the primary device that it has moved a bit to the left in its own coordinate system, and the primary device has measured that that peripheral phone is in portrait orientation and it came closer, then it knows that the peripheral is at the right. If it was to the left it would have moved away from the primary device. The movement to be used for ambiguity resolution could be the movement that happened when the peripheral phone or the primary device were put down on the table in the first place. This concept can be used to resolve most cases of ambiguity.

The present invention may also provide new capabilities for estimating more position parameters with limited number of acoustic transducers on each device.

In the general case for a handheld device it has six DOF to move, x, y, z for translations and α, β, γ for rotations. To be able to position two devices relative to one another in 6 DOF, we need at least six independent measurements of distances between the two devices. When the devices are laying flat on a table they have three DOF to move, x, y and α (azimuth rotation).

Thus, the present invention may in practice according to the following scheme:
One single generic app is used on the mobile phone for all IoT devices
Compatible IoT devices in the environment are detected by that they emit ultrasound pulses.
The direction to each detected device is obtained from the direction of arrival of the ultrasound signal.
The phone is (e.g. bluetooth) connected to a desired device by approaching that device and/or doing a gesture with the phone (recognized by the IMU on the phone).
The connection is authenticated by the mobile sending an ultrasound code requested from the IoT device
The device specific GUI is transferred to the phone via bluetooth or other radio channel. This should be in a generic standard such as a html or pdf file. Control commands are sent via bluetooth.

Compatible IoT devices in the environment are detected by that they emit ultrasound pulses
1) All compatible IoT devices send a standard ultrasound pulse at random times every n-th second. At the same time, a signal is sent over Bluetooth.
2) The mobile compares the time of the received ultrasound pulse with Bluetooth and thus identify each device in ultrasound range.
3) The direction to each detected device in mobile coordinates is obtained from the direction of arrival of the ultrasound signal, or by combining ultrasound signal with motion estimates based on the IMU on the phone. For example, this may be obtained using one of the four following alternatives: Direction is estimated with two closely spaced microphones (<4 mm) by measuring the relative phase between the two microphones.
4) Direction may be estimated with two separated microphones, both near top of phone. Ambiguity caused by microphone separation and wavelength may be resolved by comparing relative phase shifts with measurements performed using Inertia Measuring Unit (IMU) detecting movements.
5) Direction may be estimated by means of a microphone combined with the IMU data available on the mobile, for example by detecting the direction of movement and the corresponding change in the signals from the microphone by measuring corresponding phase or frequency change during the movement.
6) Knowing that the acoustic transmitter is stationary and also knowing the characteristics of the transmitted signal it may also be possible to confirm the direction of movement toward the transmitter using only a phase or frequency measurement using one microphone.

Points 4),5), and 6) require some movement of the phone, for example in the horizontal plane. It also requires a continuous signal transmitted from the IoT device during this gesture. This may be a different signal (another frequency or chirp) than the discovered initial signal.

An example of the method according to the invention is illustrated in FIG. 2, wherein the first device detects 21, possibly after being activated as a feature by the user, an acoustic signal having a known characteristic indicating the possibility to provide a wireless connection to the second device including the acoustic source. The orientation or movement of the first device relative to the second device is detected 22 and if not within the specific range of direction or orientation the device returns to the initial state 21.

If the orientation or translation movement is within the specified limits, the device initiates the wireless communication 23, either by returning a confirmation and identifying codes by acoustic or wireless communication. If accepted by the second device the communication is then established 24.

After initiating the connection it may be authenticated by the mobile sending an ultrasound code requested from the IoT device, for example in that:
The IoT device requests over Bluetooth that the mobile device sends a specified ultrasound code to establish connection. The code can be a series of pulses with specified frequencies, a sequence of chirps with specified intervals, or other codes.
The mobile device answers if this is the IoT device that the user wants to connect to (the device is pointing towards).

To summarize the present invention relates to a system as well as a system for establishing wireless connection between a mobile first device and a second device. Both devices configured for wireless communication using a known communication protocol for example using WiFi, Bluetooth etc and the second device includes an acoustic transmitter configured to transmit acoustic signals in the ultrasound range.

The first device comprises two or more transducers of which at least one is an acoustic receiver configured to receive signals within the ultrasonic range and at least partially based on the received acoustic signal, where the second and additional transducers may be a second acoustic transducer, an inertia measuring device, compass, etc, and to calculate the movement of the first device relative to the second device. The first device is configured to initiate the wireless communication when the movement of the first device is within determined limits, for example the direction and/or orientation, relative to the direction toward the second device.

The first device preferably includes two acoustic receivers, where the receivers are positioned at a known distance from each other. The device is thus configured to detect the direction toward the second device, and to initiate communication to the second device if the orientation is within predetermined limits relative to the direction toward the second device, for example being pointed at the second device.

At least one of the receivers may be configured to provide a phase delay at 45 degrees so as to increase the accuracy of the orientation measurement when the incoming acoustic signal is propagated in a preferred direction between the first and second device for initiating the communication. Alternatively, the receivers may be positioned in the first device along a line in preferred direction chosen to initiate the communication, the distance chosen to provide a chosen phase delay when in line with the second device.

The acoustic signal may be encoded, e.g. including information identifying the second, transmitting device and/or the connectability of the transmitting device. The information may then be readable for the first, receiving device so as to enable connection.

The invention also relates to a mobile device suitable for establishing wireless communication with a stationary device. The mobile device includes a receiver unit for allowing wireless communication using a known protocol, and at least two transducers of which at least one is an acoustic receiver configured to receive signals within said ultrasonic range wherein the first device is configured to measure at least partially based on the acoustic signal received at said receiver and calculate the movement of the first device relative to the second device transmitting an acoustic signal. The second transducer may be configured to measure movement or direction related to the stationary device. The mobile device is configured to initiate the wireless communication when the orientation or movement of the first device is within predetermined limits relative to the direction toward the acoustic source, for example by being oriented within a few degrees relative to the direction toward the stationary, second device and/or being moved in the direction toward the known or measured position of the stationary device.

As stated above the mobile device may include two acoustic receivers where the receivers being positioned at a known distance from each other. The mobile device being configured to detect the direction toward the second device, and to initiate communication to the second device when the orientation is within predetermined limits relative to the direction toward the second device.

Also, one of the receivers may configured to provide a phase delay at 45 degrees so as to increase the accuracy of the orientation measurement if the receivers are positioned along a line perpendicular to the preferred direction to the second, stationary device transmitting the acoustic signal. Alternatively the receivers may be positioned in the first device along a line in the direction acoustic source chosen to initiate the communication, the distance chosen to provide a chosen phase delay when in line with the second device.

The transmitted acoustic signal may be encoded and include information identifying the second, transmitting device and/or the connectability of the transmitting device, the information being readable for the mobile device so as to enable connection.

The present invention also relates to a method for establishing wireless connection between a first and a second devices using a wireless communication protocol. The method comprising a step of, from the second device transmitting an acoustic signal within the near ultrasound range, the first device being configured to receive said transmitted signals at at least one position in said first device and to calculate the orientation and/or movement of the device relative to the source of said acoustic signal, and to initiate the wireless communication when the orientation and/or movement is within determined limits relative to the direction toward the acoustic source.

If the first device includes two acoustic receivers and the receivers are positioned at a known distance from each other, the device is configured to detect the direction toward the second device based on the phase or time difference between the received signals, and to initiate communication to the second device when the calculated orientation is within predetermined limits relative to the direction toward the second device. In order to increase the sensitivity for phase measurements one of the receivers may provide a phase delay at 45 degrees so as to increase the accuracy of the orientation measurement. If the receivers are positioned in the first device along a line in the direction second device chosen to initiate the communication, the distance chosen to provide a chosen phase delay when in line with the second device.

1. A system for establishing wireless connection between a mobile first device and a second device, the devices being configured for wireless electromagnetic communication using a known communication protocol, the second device including an acoustic transmitter configured to transmit acoustic signals in the ultrasound range, the first device comprising at least two transducers of which at least one is an acoustic receiver configured to receive signals within said ultrasonic range, wherein the first device is configured to measure, at least partially based on the acoustic signal received at said receiver, a movement of the first device relative to the second device, and wherein the first device is configured to initiate the wireless communication when the movement of the first device is within determined limits relative to the direction toward the second device.

2. The system according to claim 1, wherein the first device includes two acoustic receivers, the receivers being positioned at a known distance from each other, the device being configured to detect the direction toward the second device, and to initiate communication to the second device when the orientation is within predetermined limits relative to the direction toward the second device.

3. The system according to claim 2, wherein at least one of the acoustic receivers is configured to provide a phase delay at 45 degrees so as to increase the accuracy of the orientation measurement.

4. The system according to claim 2, wherein the acoustic receivers are positioned in the first device along a line in the direction of the second device chosen to initiate the communication, the distance chosen to provide a chosen phase delay when in line with the second device.

5. The system according to claim 1, wherein the acoustic signal is encoded and including information identifying the second, transmitting device and/or the connectability of the transmitting device, the information being readable for the first, receiving device so as to enable connection.

6. A mobile device for establishing wireless, electromagnetic communication with a stationary device, the mobile device including a receiver unit allowing wireless communication using a known protocol, and comprising at least two transducers of which at least one is an acoustic receiver configured to receive signals within said ultrasonic range, wherein the first device is configured to measure, at least partially based on the acoustic signal received at said receiver and movement of the first device relative to the second device, and wherein the first device is configured to initiate the wireless communication when the movement of the first device is within determined limits relative to the direction toward the acoustic source.

7. The mobile device according to claim 6, the mobile device includes two acoustic receivers, the receivers being positioned at a known distance from each other, the device being configured to detect the direction toward the second device, and to initiate communication to the second device when the orientation is within predetermined limits relative to the direction toward the second device.

8. The mobile device according to claim 7, wherein at least one of the receivers is configured to provide a phase delay at 45 degrees so as to increase the accuracy of the orientation measurement.

9. The mobile device according to claim 7, wherein the receivers are positioned in the first device along a line in the direction acoustic source chosen to initiate the communication, the distance chosen to provide a chosen phase delay when in line with the second device.

10. The mobile device according to claim 6, wherein the acoustic signal is encoded and including information identifying the second, transmitting device and/or the connectability of the transmitting device, the information being readable for the mobile device so as to enable connection.

11. A method for establishing wireless, electromagnetic connection between a first and a second device using a wireless communication protocol, the method comprising a step of, from the second device transmitting an acoustic signal within the near ultrasound range, the first device being configured to receive said transmitted signals at least one position in said first device and to calculate the movement of the device relative to the source of said acoustic signal, and to initiate the wireless communication when the orientation and/or movement is within determined limits relative to the direction toward the acoustic source.

12. The method according to claim 11, the first device includes two acoustic receivers, the receivers being positioned at a known distance from each other, the device being configured to detect the direction toward the second device, and to initiate communication to the second device when the orientation is within predetermined limits relative to the direction toward the second device.

13. The method according to claim 12, wherein at least one of the receivers provides a phase delay at 45 degrees so as to increase the accuracy of the orientation measurement.

14. The method according to claim 12, wherein the receivers are positioned in the first device along a line in the direction second device chosen to initiate the communication, the distance chosen to provide a chosen phase delay when in line with the second device.

15. The method according to claim 11, wherein the acoustic signal is encoded and including information identifying the second, transmitting device and/or the connectability of the transmitting device, the information being readable for the mobile device so as to enable connection.
